(19) United States
(12) Patent Application Publication
(10) Pub. No.: US 2004/0088398 A1
(43) Pub. Date: May 6, 2004

(54) Systems and methods for providing autoconfiguration and management of nodes

(76) Inventor: Douglas B. Barlow, Orem, UT (US)

Correspondence Address: Michael F. Krieger, KIRTON & McCONKIE, Suite 1800, 60 East South Temple, Salt Lake City, UT, 84111, US

(21) Appl. No.: 10/288,929

(22) Filed: Nov. 6, 2002

(51) Int. Cl. G06F 15/173; G06F 15/177; G06F 15/16

(52) U.S. Cl. 709/223; 709/222; 709/229; 709/201

(57) ABSTRACT

Systems and methods relating to auto-configuring and completely managing nodes of a networked environment, wherein a system controller automatically identifies, analyzes, configures, and manages a collective in a networked environment. A fully managed computer system is disclosed in which computing nodes are fully initialized, controlled, installed and configured by a system controller. The system controller manages all respects of the nodes including configuration, installation, health, optimization, load balancing, etc. Accordingly, no manual configuration at the nodes themselves is needed. As a system administrator gives tasks for the system controller to implement, the system controller decides which node is appropriate for each given task. If not enough information is known to make the decision, the system controller asks the system administrator one or more questions about the specifics of the task. After receiving a response, the system controller gives instructions to one or more nodes and follows the instructions to complete the given task. The System Controller monitors the status of all tasks on each node.

### BACKGROUND OF THE INVENTION

1. Field of the Invention

The present invention relates to auto-configuring and completely managing nodes of a networked environment. More particularly, the present invention relates to systems and methods relating to providing a system controller that automatically identifies, analyzes, configures, and manages a collective in a networked environment.

2. Background and Related Art

A variety of computerized devices are currently available for use, including personal computer systems, notebook computers, handheld units, workstations, mainframes, routers, switches, and hubs. The devices may be used in networked environments, which have created a variety of configuration, maintenance, and security challenges.

Networked environments provide many time consuming and tedious tasks for network technicians to perform in order to manage the networked systems. For example, newly connected devices need to be installed and configured, previously connected devices need to be maintained, new releases of software applications need to be installed, and problematic devices and/or configurations need to be diagnosed, fixed and/or replaced.

Users who are unfamiliar with proper network configurations may inadvertently disable a device being used and/or the network. For example, a user other than a network administrator may be legitimately working on or around one or more network nodes and unintentionally alter the configuration resulting in a situation where one or more of the networked devices are no longer properly configured for use. An example may include a user changing a network setting, causing a computer to be unable to communicate across a network. Alternatively, a user may install software on a computer, wherein the installation changes system components of the computer, causing the computer to act in an unstable manner. Moreover, a user may delete a critical file in a system directory, causing the computer to be problematic or unusable. Accordingly, the network administrator would be required in each of the examples to spend time and effort in remedying the erroneous configuration.

A large number of devices or resources on a network can also cause difficulty in efficiently managing the operating capacity of the networked system. Greater demands on the network may require additional or more powerful devices to be added to service the demand. Further, it is usually easier and more cost effective to obtain additional devices or units for the network than to have the network administrator reallocate tasks to each node in order to maximize the operating capacity of the current devices. Accordingly, time and/or resources can be wasted by current technologies.

Current network techniques can also be susceptible to a security breach through remote devices. Because all of the devices in a network are connected, it is possible for an unauthorized user to gain access to all of the devices by gaining unauthorized access to one of the devices. Various security measures (e.g., authentication and encryption procedures) can be taken to help minimize security breaches. Thus, while existing techniques do allow for the networking of computerized devices, these techniques also create additional tasks, problems, required maintenance, and security issues. Accordingly, it would be an improvement in the art to augment or even replace current techniques with other techniques.

### SUMMARY OF THE INVENTION

The present invention relates to auto-configuring and completely managing nodes of a networked environment. More particularly, the present invention relates to systems and methods relating to providing a system controller that automatically identifies, analyzes, configures, and manages a collective in a networked environment. Implementation of the present invention relates to the use of a system controller to manage nodes of a computer system. In at least one implementation, the system is a task-based system, wherein the system administrator informs the system controller what tasks are to be performed and then the system controller automatically decides which tasks are assigned to each node. If the system controller needs more details about a certain task, it will ask the system administrator questions in order to obtain the needed information.

Each of the nodes of the system can be any type of a computer device or other device, including a personal computer, a computing appliance, a network switching device, a router, a handheld device, or the like. In at least one implementation of the present invention, no node is directly configured by an end-user. Instead, all configuration changes come from an authenticated system controller.

The system controller and all of the nodes that the system controller controls are referred to as a collective. In at least one implementation, software is installed on one or more devices of the collective using a guardian, which is in charge of compiling and warehousing software that will be installed on the collective. If instructed by the system controller to install software on the collective, the guardian builds optimized software that is tailored to the hardware specifications given by the system controller for each node of the collective. The guardian distributes software to the collective when the system controller has authorized the distribution of such software.

In at least one implementation, the system controller completely manages and controls all aspects of the nodes of the collective, including instructing the nodes to initialize themselves, formatting storage devices, instructing the nodes to run tests on themselves to determine each node's health, and other useful processes. The system controller further instructs each node to profile itself and send back information to the system controller to determine how current software packages are running so that the system controller can determine if each node can be optimized further.

The system controller also determines if resources are properly allocated. For example, if a software package is overwhelming the resources of a node, the system controller may move the software package to another node. If there aren't any nodes that will handle the load, the system controller will request that a system administrator add one or more resources to a node or even add more nodes to the collective.

While the methods and processes of the present invention have proven to be particularly useful when implemented over a Local Area Network (LAN), those skilled in the art can appreciate that the methods and processes can be used in a variety of different system configurations, including wide area network connection, wireless network connections, and the like.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative computer device for use in accordance with the present invention;

FIG. 2 illustrates a representative networked system configuration in accordance with an embodiment of the present invention;

FIG. 3 is a flow chart that provides a representative initialization process of an un-configured node in accordance with an embodiment of the present invention;

FIG. 4 is a flow chart that provides a representative process for allowing a system administrator to log into a system controller in accordance with an embodiment of the present invention;

FIG. 5 is a flow chart that provides representative process in which a node is added to a collective owned by a particular system controller in accordance with an embodiment of the present invention;

FIG. 6 is a flow chart that provides a representative process illustrating how a system controller authenticates itself to a node in accordance with an embodiment of the present invention;

FIG. 7 is a flow chart that provides a representative process that allows a system administrator to selectively configure a system controller in accordance with an embodiment of the present invention; and

FIG. 8 is a flow chart that provides a representative process that allows a system controller to selectively configure a node in accordance with an embodiment of the present invention.

### DETAILED DESCRIPTION OF THE INVENTION

The present invention relates to auto-configuring and completely managing nodes of a networked environment. More particularly, the present invention relates to systems and methods relating to providing a system controller that automatically identifies, analyzes, configures, and manages a collective in a networked environment.

Embodiments of the present invention embrace the use of a system controller to manage nodes of a computer system. In one embodiment, a system administrator of a task-based system informs the system controller what tasks are to be performed and then the system controller decides which tasks are assigned to each node. If the system controller needs more details about a certain task, it will ask the system administrator questions in order to obtain the needed information.

The system controller and all of the nodes that the system controller controls comprise a collective. In one embodiment, software is installed on one or more devices/nodes of the collective using a guardian, which compiles and warehouses software for use by the collective. If instructed by the system controller to install software on the collective, the guardian builds optimized software that is tailored to the hardware specifications given by the system controller for each node of the collective. The guardian distributes software to the collective when the system controller has authorized the distribution of such software.

The system controller manages and controls all aspects of the nodes of the collective, including instructing the nodes to initialize themselves, formatting storage devices, instructing the nodes to run tests on themselves to determine each node's health, and other useful processes. The system controller instruct each node to profile itself and send back information to the system controller to determine how current software packages are running and if they can be optimized further.

The system controller also determines if resources are properly allocated. For example, if a software package is using too many resources on a node, the system controller may move the software package to another node. If there aren't any nodes that will handle the load, the system controller will request that a system administrator add one or more resources to a node or even add more nodes to the collective.

The following disclosure of the present invention is grouped into two subheadings, namely “Exemplary Operating Environment” and “Representative Methods of Operation.” The utilization of the subheadings is for convenience of the reader only and is not to be construed as limiting in any sense.

### Exemplary Operating Environment

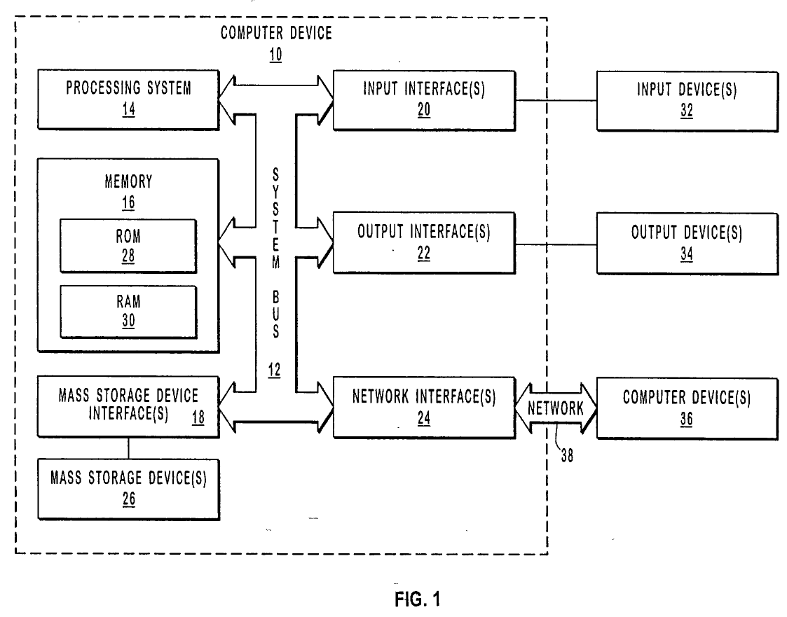

As provided above, embodiments of the present invention embrace systems and methods providing a system controller that automatically identifies, analyzes, configures, and manages nodes of anetworked environment. As the system controller and/or nodes of the computer system or collective can comprise one or more computer devices used to selectively perform tasks, FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

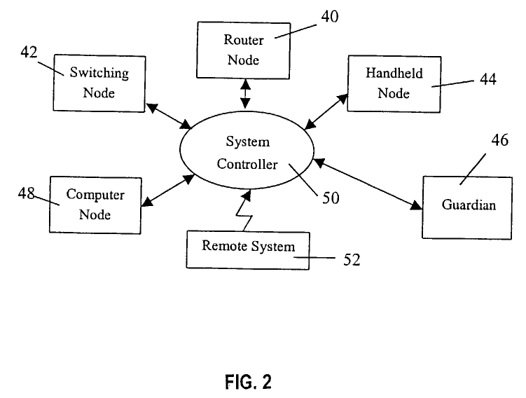

While those skilled in the art will appreciate that the invention may be practiced in networked computing environments with many types of computer system configurations, FIG. 2 represents an embodiment of the present invention that includes a system controller that selectively communicates with a plurality of nodes. In FIG. 2, a network architecture is illustrated in a hub and spoke configuration that includes a system controller as a central hub that is connected to a variety of nodes. The nodes include one or more computer devices (e.g., router node 40, switching node 42, handheld node 44, and computer node 48) or other types of devices connected to the system controller, such as via a network. These nodes may be previously configured by their manufacturers or completely un-configured and un-initialized.

A system controller and one or more corresponding nodes are referred to herein as a collective, which obtains any software it uses from a trusted storage site referred to herein as a guardian (e.g., guardian 46). The guardian may be on the same network or on a remote network, is a software warehouse, is charged with keeping safe the software it controls, and has the ability to create custom versions of software with optimizations given it by any system controller. Optimizations can include compiler codes to make the software run faster on given nodes. The guardian also acts as a version control system and repository. It keeps sets of files grouped together for use with a software package. In the example of a web server, the system controller asks the guardian for the previously prepared web pages to be installed with a web server software package.

Accordingly, system controller 50 is the managing entity of the representative collection illustrated in FIG. 2. System controller 50 is comprised of a computer device or of a collection of computer devices that share the responsibility of the system controller 50. By way of example, system controller 50 configures each node to operate under its management. In one embodiment, System controller 50 is aware of the tasks to be completed by the system and of the operating capacities of each node in its collective. It is thus able efficiently manage the tasks given to the networked system by assessing which nodes would be most effective in carrying out specific tasks. If the resources of the networked system are not sufficient to adequately perform all of the tasks assigned to the system, the System controller 50 may configure new nodes to operate under its management within its collective.

System controller 50 configures and manages the nodes (e.g., nodes 40-44 and 48) automatically, thereby relieving a network administrator of personally configuring and reconfiguring each node and of personally allocating tasks to various nodes by manually assessing the operating capacities of each node and assigning and re-assigning tasks. In one embodiment, system controller 50 has the ability to profile and optimize the networked system. For example, the system controller may experiment, learn, and remember which configurations and optimizations worked the most effectively and efficiently. Furthermore, the system controller may learn which nodes are best for certain tasks, which nodes work most efficiently together, and what software optimizations increase the productivity of each node. In a further embodiment, the system controller may either suggest modifications to a network administrator or automatically configure and tune the networked system. In another embodiment, the system controller manages the tasks of reconfiguring each node, erasing any previous and unused software, transferring the appropriate software packages, and minimizing the down time of each node.

In one embodiment, each node is fully controlled by the system controller 50. Accordingly the node will not accept any input or display any output at the device itself except in rare cases of hardware failure. In another embodiment of the invention, applications running on the node distrust by design other applications running on the particular node. In another embodiment, the operating system of the node may be configured in such a way that no application may access the local resources of another application. Accordingly, each application only accesses the resources that the node has allocated for its use. While this embodiment may require the system to have more total resources at its disposal, it prevents the system from slowing down or freezing if two or more applications need to use a shared resource. Additionally, available operating capacity on each node will not be in constant flux, making it easier for the system controller to assess how many more tasks a particular node can perform. Should an application need a particular resource, it requests it from the node, which in turn requests it from the system controller. The System controller checks the request against the any pre-established rules. If the request is in accordance with the rules, the resource is allocated for use by the application.

The network administrator is a person or persons who manage the system controller. In the illustrated embodiment, system controller 50 only makes decisions to the extent that a network administrator has indicated. If system controller 50 does not have enough information or authority from the administrator to make a decision, it asks the administrator for authorization of a decision or for more information upon which to make the decision. The administrator configures the system controller and determines what the tasks of the networked system will be and assigns implementation and management of the tasks to the system controller. In configuring system controller 50, the administrator instructs system controller 50 as to which nodes it is to manage and control.

Accordingly, in one embodiment the administrator may instruct the system controller to search for any remote resources and/or nodes to which the system controller is connected. The administrator may then decide which of the nodes should be added to the system controller's collective and instruct the system controller accordingly.

As illustrated in FIG. 2, one or more remote systems 52 may be connected to system controller 50. In one embodiment, remote system 52 allows a network administrator to access system controller 50 without physically being present at system controller 50. In another embodiment, the remote system includes one or more collectives and a master system controller that manages all of the system controllers.

As provided above, the illustrated embodiment of FIG. 2 also includes a guardian 46, which is a secure software storage site that the System controller 50 may selectively use to allocate properly configured software to various nodes so that they will be able to efficiently carry out their assigned tasks. This may be classified as a node depending on the degree of control that the system controller exercises over it and the amount of computing capacity that it contains. Guardian 46 is charged with keeping the software safe and, in one embodiment, also has the ability to create and store custom versions of software with optimizations given it by system controller 50. Guardian 46 may either be connected directly to the system controller or via a network that the system controller and the nodes are also connected thereto.

### Representative Methods of Operation

As provided above, embodiments of the present invention embrace systems and methods relating to providing a system controller that automatically identifies, analyzes, configures, and manages nodes of a computer system. Advantages of such systems and methods include an increase in efficiency by automatically carrying out tasks, ensuring that tasks are properly performed, allocating use of available resources, increased security of the networked systems, and the like.

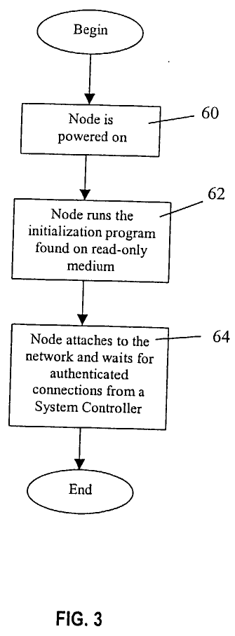

With reference to FIG. 3, a flow chart is illustrated that provides a representative initialization process of an un-configured node in accordance with an embodiment of the present invention. In FIG. 3, execution begins at step 60, where the node is powered on. At step 62 the node runs the initialization program found on a read-only medium. At step 64, the node attaches to the network and waits for authenticated connections from a system controller.

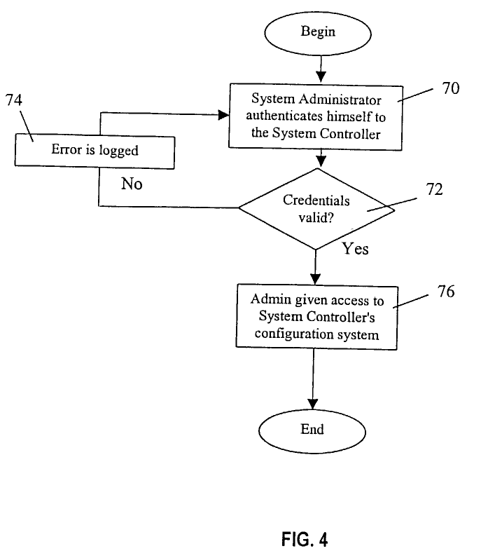

With reference to FIG. 4, a flow chart is illustrated that provides a representative process for allowing a system administrator to log into a system controller in accordance with an embodiment of the present invention. In FIG. 4, execution begins at step 70, wherein an administrator logs onto the system controller (either physically at the system controller or from a networked remote system or wireless remote system) and performs an authentication process to the system controller as an authorized administrator. A determination is then made at decision block 72 as to whether or not the authentication is valid. If the system controller's credentials are valid, the administrator is given access to the system controller's configuration system at step 76. Alternatively, if the credentials are not valid, an error is logged of the attempted login at step 74.

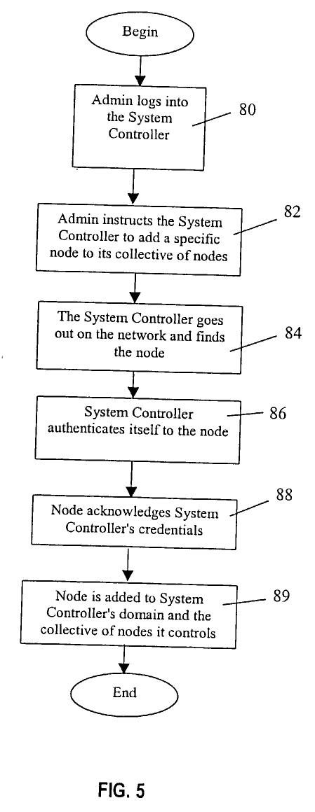

With reference now to FIG. 5, a flow chart is illustrated that provides a representative process in which a node is added to a collective owned by a particular system controller in accordance with an embodiment of the present invention. In FIG. 5, execution begins at step 80 where the administrator logs into the system controller. At step 82, the administrator instructs the system controller which nodes on the network, either physically wired together or connected wirelessly, are to be managed and controlled by the system controller. At step 84, the administrator may also instruct the system controller to search for nodes on any network to which the system controller is connected that also could be managed by the system controller. The administrator then determines which set of nodes will be controlled and managed by this system controller, which then contacts each node and authenticates itself at step 86. At step 88 the node acknowledges the credentials of the system controller and then the node is added to the system controller's domain and the collective of nodes controlled by the system controller at step 89.

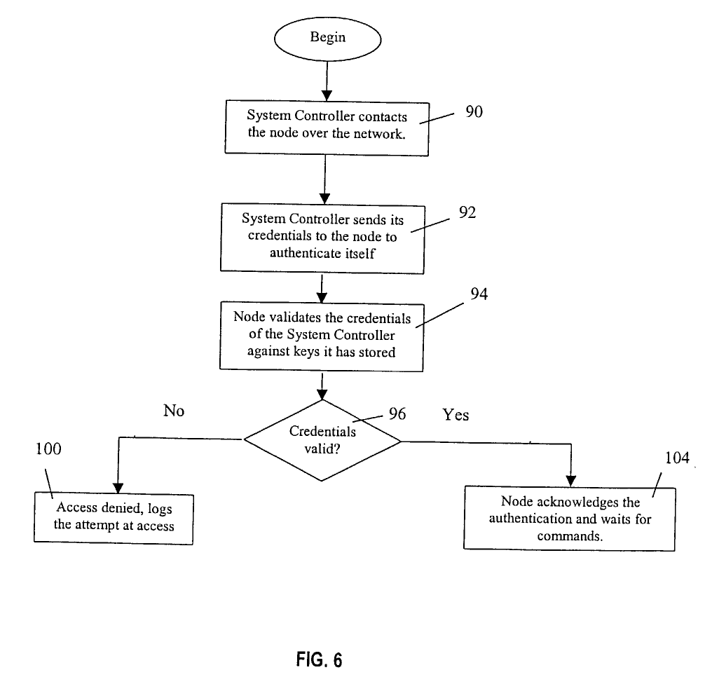

With reference now to FIG. 6, a flow chart is illustrated that provides a representative process illustrating how a system controller authenticates itself to a node in accordance with an embodiment of the present invention. In FIG. 6, execution begins at step 90, wherein the system controller contacts the node over the network. At step 92, the system controller sends its credentials to the node for authentication. At step 94, the node validates the credentials of the system controller by checking keys stored locally at the node. A determination is then made at decision block 96 as to whether or not the credentials are valid. If the credentials are valid, the node acknowledges the authentication and waits for commands from the system controller at step 104. Alternatively, if the credentials are not valid, the node closes the connection and denies access at step 100.

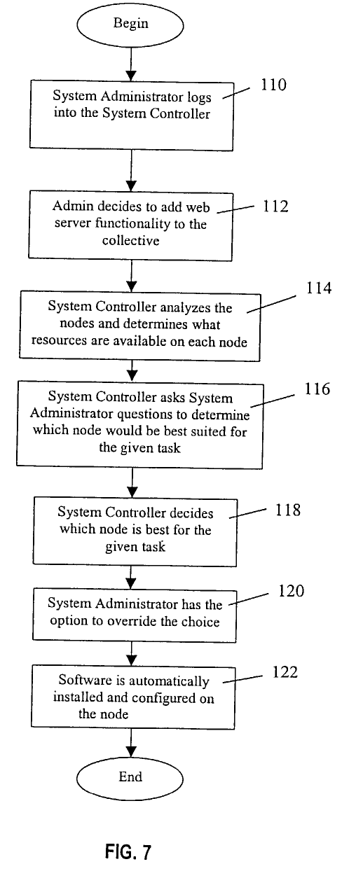

With reference now to FIG. 7, a flow chart is illustrated that provides a representative process that allows a system administrator to selectively configure a system controller in accordance with an embodiment of the present invention. In FIG. 7, execution begins at decision block 110, wherein the system administrator logs onto the system controller. The administrator then determines the tasks of the collective. One such example of tasks includes server tasks, wherein the administrator may instruct the system controller to configure a web server, an email server, a DNS server, or the like. This is illustrated by step 112, wherein the administrator decides to add web server functionality to the collective. Any software package that has been prepared to run on this architecture may be installed on the collective.

At step 114, the system controller determines the capabilities of each node. At step 116, the system controller asks the system administrator questions about the tasks to be performed. In the case of a web server, the system controller may ask about how heavy the usage will be of the web server. For example, will it be used internally or externally? After asking any necessary questions, at step 118 the system controller decides which node is best for performing the task. In some embodiments, the system administrator is allowed to override the decision made by the system controller, as illustrated by step 120. The system controller may ask the administrator questions to determine why its decision was overridden. Then, at step 122 the system controller sends the node its new tasks and authorization for installing any new software for the node to use.

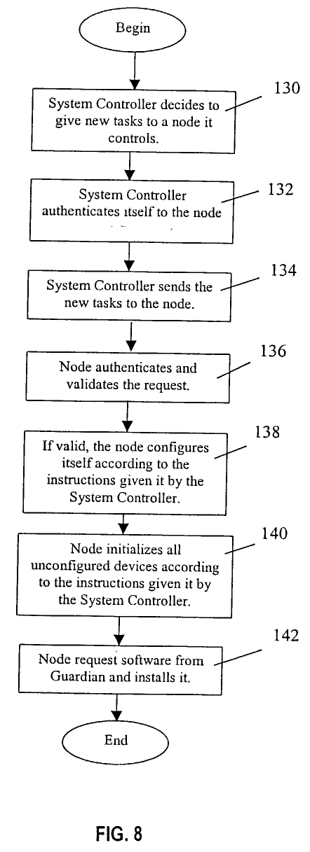

With reference now to FIG. 8, a flow chart is illustrated that provides a representative process that allows a system controller to selectively configure a node in accordance with an embodiment of the present invention. In FIG. 8, execution begins at step 130, wherein the system controller decides to give new tasks to a node that it controls. At step 132, the system controller authenticates itself to the node. At step 134, the system controller sends the list of instructions to the node. The node validates the request at step 136. If valid, the node configures itself according to the instructions at step 138. At step 140, the system controller instructs the node to erase any previous software on the node and reformats all storage devices or any un-initialized devices. At step 132, the system controller authenticates itself to the guardian and requests for a software package that may be installed on its collective. The system controller has the option to ask for a generic version of a software package or an optimized version. The guardian sends the node the software package and then the system controller configures that software package on the node. This process is performed for all selected nodes until all tasks are assigned.

The system controller also has the ability to profile and optimize the collective. It can experiment, learn, and remember which configurations and optimizations worked the most efficiently. It can make suggestions to the administrator or even configure and tune the collective to leverage the strengths of each node. The system controller also has the ability to change the assignments of each node. If an administrator would like two nodes to swap assignments, the system controller handles the tasks of reconfiguring each node, transferring the appropriate software packages, and minimized down time of each node. All this is done without any need for the administrator to directly configure any node. As a collective reaches its maximum capacity, the system controller may notify the administrator that the collective needs some additional resources such as storage devices, additional nodes, more system memory on a particular node, etc.

Thus, as discussed herein, embodiments of the present invention embrace auto-configuring and completely managing nodes of a networked system. More particularly, the present invention relates to systems and methods relating to providing a system controller that automatically identifies, analyzes, configures, and manages a collective in a networked system. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An automatically configuring computer system comprising:
a network that enables a transfer of information;
a node connected to the network; and
a system controller connected to the network, wherein the system controller is configured to automatically manage the node.

2. An automatically configuring computer system as recited in claim 1, further comprising a remote system connected to the network.

3. An automatically configuring computer system as recited in claim 1, further comprising a guardian connected to the network.

4. An automatically configuring computer system as recited in claim 3, wherein the guardian stores software that may be automatically installed on the node by the system controller.

5. An automatically configuring computer system as recited in claim 3, wherein the guardian protects software that may be automatically installed on the node by the system controller.

6. An automatically configuring computer system as recited in claim 1, wherein the computer system is a task-based system.

7. An automatically configuring computer system as recited in claim 1, wherein the system controller is configured to automatically determine which tasks are to be assigned and performed by the node.

8. An automatically configuring computer system as recited in claim 1, wherein the node is a computer device.

9. An automatically configuring computer system as recited in claim 1, wherein the node is configured by the system controller.

10. An automatically configuring computer system as recited in claim 1, wherein the network includes one of:
(i) a local area network;
(ii) a wide area network; and
(iii) a wireless network.

11. In a system that includes a system controller coupled to one or more nodes in a collective via a network, a method for managing the nodes, the method comprising the steps for:
using the system controller to identify a node connected to the network; and
using the system controller to automatically manage use of the node.

12. A method as recited in claim 11, wherein the step for using the system controller to identify a node comprises at least one of the steps for:
(i) automatically initializing the node, wherein the node is an un-configured node;
(ii) automatically identifying the node to operate within the collective, wherein the collective is managed by the system controller;
(iii) automatically adding the node to the collective;
(iv) automatically authenticating the system controller to the node; and
(v) automatically identifying one or more operating abilities of the node.

13. A method as recited in claim 12, wherein the steps for automatically initializing the node, automatically identifying the node to operate within the collective, automatically adding the node to the collective, automatically authenticating the system controller to the node, automatically configuring the node to perform a task, and automatically identifying one or more operating abilities of the node are performed by the system controller.

14. A method as recited in claim 11, wherein the step for using the system controller to automatically manage use of the node comprises the steps for:
comparing operating abilities of the node with one or more tasks that are to be performed; and
automatically assigning one or more of the one or more tasks to the node for processing.

15. A method as recited in claim 11, wherein the step for using the system controller to automatically manage use of the node comprises at least one of the steps for:
(i) automatically configuring the node to perform a task;
(ii) automatically updating software of the node from a guardian;
(iii) optimizing software that is tailored to hardware specifications of the node;
(iv) instructing the node to initialize itself;
(v) initiating a formatting of a storage device associated with the node;
(vi) initiating a diagnostic test on the node;
(vii) initiating a profile of the node;
(viii) initiating a processing status report that is provided to the system controller; and
(ix) determining whether resources of the collective are appropriately allocated.

16. A method as recited in claim 15, wherein the step for automatically updating software of the node comprises the step for distributing the software to the node from a guardian upon approval of the system controller.

17. A computer program product for implementing within a computer system a method for automatically managing a one or more nodes, the computer program product comprising:
a computer readable medium for providing computer program code means utilized to implement the method, wherein the computer program code means is comprised of executable code for implementing the steps for:
using the system controller to automatically identify a node connected to the network; and
using the system controller to automatically manage use of the node in the system.

18. A computer program product as recited in claim 17, wherein the step for using the system controller to identify a node comprises at least one of the steps for
(i) automatically initializing the node, wherein the node is an un-configured node;
(ii) automatically identifying the node to operate within the collective, wherein the collective is managed by the system controller;
(iii) automatically adding the node to the collective;
(iv) automatically authenticating the system controller to the node; and
(v) automatically identifying one or more operating abilities of the node.

19. A computer program product as recited in claim 17, wherein the step for using the system controller to automatically manage use of the node comprises the steps for:
comparing operating abilities of the node with one or more tasks that are to be performed; and
automatically assigning one or more of the one or more tasks to the node for processing.

20. A computer program product as recited in claim 17, wherein the step for using the system controller to automatically manage use of the node comprises at least one of the steps for:
(i) automatically configuring the node to perform a task;
(ii) automatically updating software of the node from a guardian;
(iii) optimizing software that is tailored to hardware specifications of the node;
(iv) instructing the node to initialize itself;
(v) initiating a formatting of a storage device associated with the node;
(vi) initiating a diagnostic test on the node;
(vii) initiating a profile of the node;
(viii) using the system controller to completely manage the node to provide enhanced security;
(ix) initiating a processing status report that is provided to the system controller; and
(x) determining whether resources of the collective are appropriately allocated.
